(19) United States
(12) Patent Application Publication
(10) Pub. No.: US 2005/0003313 A1
(43) Pub. Date: Jan. 6, 2005

(54) Radiographic silver halide photographic material having excellent preservation characteristics

(76) Inventor: Dirk Bollen, Sint-Truiden (BE)

Correspondence Address: Joseph T. Guy Ph.D.;Nexsen Pruet Jacobs & Pollard LLP, 201 W. McBee Avenue, Greenville, SC, 29603, US

(21) Appl. No.: 10/871,797

(22) Filed: Jun. 18, 2004

Related U.S. Application Data
(60) Provisional application No. 60/483,834, filed on Jun. 30, 2003.

(30) Foreign Application Priority Data
Jun. 19, 2003 (EP) 03101809.6

(51) Int. Cl. G03C 1/46

(52) U.S. Cl. 430/567

(57) ABSTRACT

A blue-sensitized black-and-white silver halide negative working photographic material has been disclosed, wherein said material comprises a support having thereon at least one light-sensitive silver halide emulsion layer containing tabular silver halide grains and wherein the said material further comprises in at least one emulsion layer or in a non-light-sensitive layer adjacent thereto, a heteroatomic sulfinic acid compound, a disulfide compound or a combination thereof, wherein each of said compounds has a solubilizing group having a pKₐ-value of 10 or less.

The application claims the benefit of U.S. provisional application No. 60/483,834 filed Jun. 30, 2003

### FIELD OF THE INVENTION

The present invention relates to a silver halide photographic material, particularly suitable for radiographic imaging, and a solution for the preservation of said material before exposure.

### BACKGROUND OF THE INVENTION

Since the early eighties practical use of light-sensitive tabular silver halide grains or crystals has become common knowledge for anyone skilled in the art of photography. From Eastman Kodak's basic patents relied thereupon those related with the preparation of {111} tabular silver halide grains, sensitivity increase by spectral and chemical sensitization, and coating in a light-sensitive silver halide photographic material, more particularly in a forehardened duplitized radiographic material showing improved covering power for tabular grains having a thickness of less than 0.20 μm as described in U.S. Pat. No. 4,414,304 and in the patents corresponding therewith in Japan and in the European countries, it becomes clear that problems encountered by making use of such grains are related with image tone and developability as has also been set forth in U.S. Pat. No. 5,595,864.

In radiographic applications the film materials are coated with relatively high amounts of silver, in order to provide a suitable sensitometry even if a low radiation dose is applied to the patient as is always desirable. Although the use of {111} tabular silver halide grains permits coating of lower amounts of silver, if compared e.g. with grains having a more globular shape as applied before practical application of said tabular grains, there remains the need to provide an acceptable image tone after development of materials having light-sensitive silver halide layers containing said tabular grains. Reduction of thickness of the {111} tabular grains coated in a radiographic film material hitherto, although providing a higher covering power, remains unambiguously related indeed with the occurrence, after processing of such materials, of diagnostic images having an unacceptable reddish-brown image tone for radiologists as image tone and image quality are closely related with each other in the specific context of examination of diagnostic images. Measures taken in order to get a shift in image tone from reddish-brown to the desired bluish-black color of the developed silver, well-known from the state-of-the-art are hitherto unsatisfactory. Coating light-sensitive emulsion layers on a blue base as in U.S. Pat. No. 5,800,976 makes increase minimum density, a phenomenon which is interpreted by the radiologist as an undesired increase of “fog density”. Incorporation in the other layers of the film material of such dyes or dye precursors providing blue color directly or indirectly (by processing and oxidative coupling reactions) are e.g. known from U.S. Pat. Nos. 5,716,769 and 5,811,229 and EP-A 0 844 520, and JP-A 10-274 824 respectively and causes the same problems as set forth hereinbefore, moreover showing, in the worst cases, staining of the screens with blue dyes diffusing from the material onto the screen, with residual color of dyes due to uncomplete removal of said dyes in, nowadays desired, rapid processing steps and problems related with criticality of generation of imagewise developed blue colored silver and preservation characteristics of the material.

Radiographic elements exhibiting increased covering power and colder image tones have been published in U.S. Pat. Nos. 5,795,795; 5,800,976 and 5,955,249.

More recently very effective measures in order to improve image tone have been described in EP-A's 1 103 847, 1 103 848, 1 103 849 and 1 103 850.

Apart from an improved image tone it has always been an important goal to have stable materials: preservation of said materials in severe circumstances with respect to heat and humidity before exposure remains important.

The stringent demand thus remains to get a desired blue-black image tone of a diagnostic image without disturbing residual color obtained after processing of the radiographic light-sensitive silver halide film material, wherein the said material has suitable preservation characteristics before use. Besides attempts in order to optimize the relationship between image tone, covering power and improved preservation characterics made in EP-A's 1 262 824 and 1 262 825 and in U.S. Pat. Nos. 6,348,293; 6,346,360 and 6,342,338; U.S. Pat. No. 4,740,454 is referred to as relating to a silver halide photographic material having improved sharpness over a wide range from the high frequency area to the low frequency area.

### OBJECTS AND SUMMARY OF THE INVENTION

Therefore, an object of the present invention is to provide a silver halide photographic material showing, after preservation, no loss in sensitivity (speed) or contrast reduction for blue-sensitized radiographic film materials having tabular grain emulsions, when having been exposed and processed.

Other objects of the present invention will become apparent from the following detailed description and from the Examples.

The above-mentioned advantageous effects have been realized by providing a blue-sensitized black-and-white silver halide negative working photographic material having the specific features set out in claim 1. Specific features for preferred embodiments of the invention are set out in the dependent claims.

Further advantages and embodiments of the present invention will become apparent from the following description.

As an advantageous effect presence in said emulsion layer having blue-sensitized tabular grains as defined in the description and in the claims, or in a layer adjacent thereto, of a heteroatomic sulfinic acid compound, a disulfide compound or a combination thereof, wherein each of said compounds has a solubilizing group having a pKₐ-value of 10 or less, provides remarkably improved preservation characteristics before exposure and processing of said blue-sensitized film materials.

### DETAILED DESCRIPTION OF THE INVENTION

According to the present invention a black-and-white silver halide negative working photographic material is spectrally sensitized in the wavelength range below 500 nm, and at least one light-sensitive emulsion layer thereof comprises tabular grains having a thickness in the range from 0.05 μm up to 0.25 μm, more preferably in the range from 0.07 μm up to 0.25 μm and most preferably in the range from 0.10 μm up to 0.25 μm, wherein said grains having an aspect ratio in the range from 5:1 up to 50:1 represent a projective surface area of at least 50% of the total projected surface of all grains present in said emulsion layer(s), wherein said material further comprises at least one compound according to general formula (I) 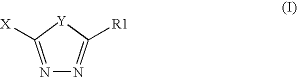
wherein:
X represents a functional group containing sulfur, apart from a thiol group or a thiolate;
Y is selected from the group consisting of an oxygen atom, a sulfur atom, NR², NNR³R⁴ and N—N═CR⁵R⁶,
R¹ is selected from the group consisting of hydrogen, a (substituted or unsubstituted, satured or unsatured) aliphatic or heteroatomic group, a (substituted or unsubstituted) aryl or heteroaryl group, S—R⁷ and NR⁸R⁹;
R², R⁵, R⁶ and R⁷ are selected from the group consisting of hydrogen, a (substituted or unsubstituted, satured or unsatured) aliphatic or heteroatomic group, a (substituted or unsubstituted) aryl or heteroaryl group;
R³, R⁴, R⁸ and R⁹ are selected from the group consisting of hydrogen, a (substituted or unsubstituted, satured or unsatured) aliphatic or heteroatomic group; a (substituted or unsubstituted) aryl or heteroaryl group, an acyl group, a sulphonyl group and a phosphoryl group;
wherein any of R³ and R⁴, R⁵ and R⁶, R⁸ and R⁹ may represent atoms necessary to form a five to eight membered, and
wherein R¹ and Y may form a five to eight membered ring,
further characterized in that at least one of Y and R¹ is substituted by a solubilizing group having a pKₐ of 10 or less.

In one embodiment according to the present invention a silver halide material comprises a compound according to general formula (I), wherein X— is represented by a group according to formula (II), 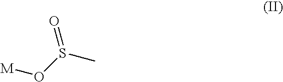
wherein M represents a hydrogen atom or a counterion.

In another embodiment according to the present invention a silver halide material comprises a compound according to general formula (I), wherein in said X— is represented by a group according to formula (III), 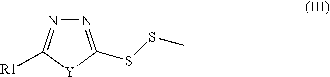
wherein Y and R¹ in formula (III) are defined as in general formula (I) given hereinbefore.

In another embodiment according to the present invention said silver halide photographic material further comprises a compound according to general formula (IV), 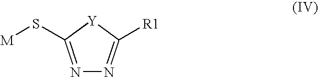
wherein Y and R1 are defined for formula (I) and wherein M represents a hydrogen atom or a counterion.

According to a preferred embodiment of the present invention said silver halide photographic material comprises at least one compound as disclosed hereinbefore, wherein said characterizing solubilizing group is selected from the group consisting of a carboxylic acid or salt thereof, a sulfonic acid or salt thereof, a phosphonate, a phosphate, a sulfate and an acylsulfonamide or salt thereof.

In a further preferred embodiment according to the present invention a silver halide photographic material as disclosed hereinbefore comprises at least one compound, wherein Y is a sulfur atom.

In another preferred embodiment said silver halide photographic material as disclosed hereinbefore comprises at least one compound according to the formulae given hereinbefore, wherein R¹— is represented by formula (V), 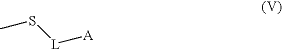
wherein:
A is a solubilizing group selected from the group consisting of a carboxylic acid, a sulfonic acid, a phosphonate, a phosphate, a sulfate and an acylsulfonamide or a corresponding salt thereof, and
L represents a (substituted or unsubstituted) aliphatic divalent linking group.

Typical examples of compounds according to general formula (II) are given below without being limited thereto.

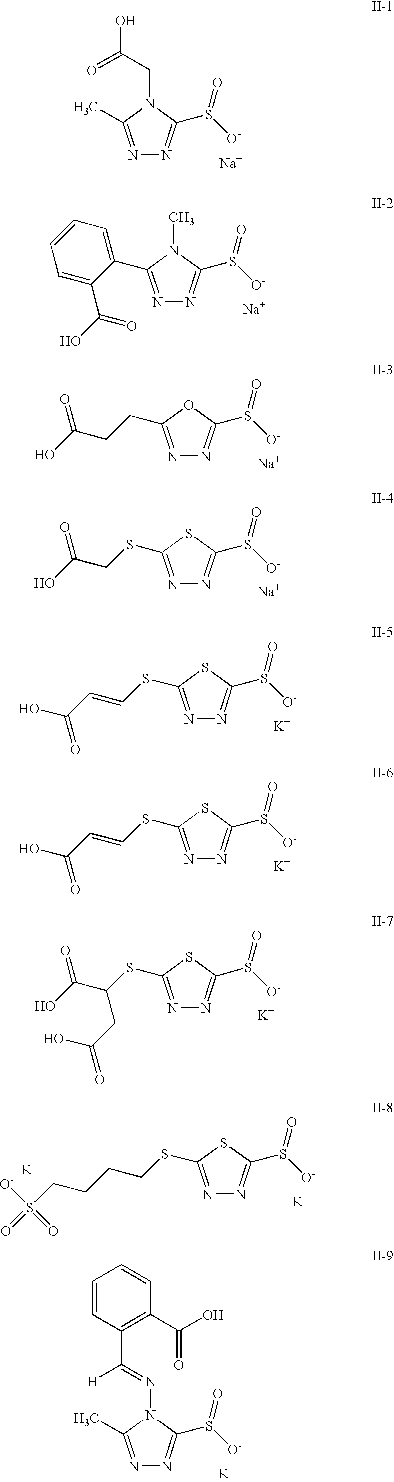

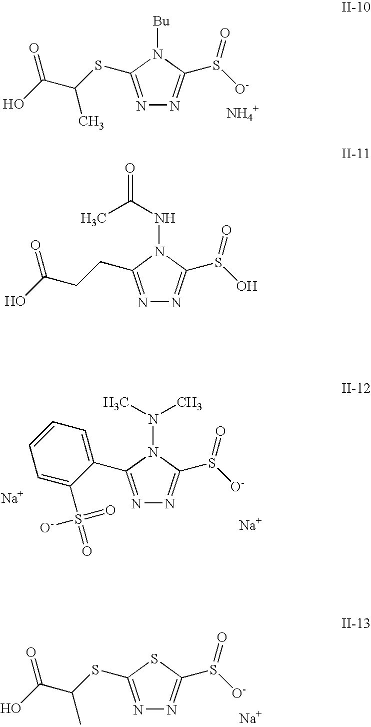

Several strategies with respect to the synthesis of heteroaromatic sulfinic acid salts have been published. Making use of thioureum dioxide as a starting material is a typical synthetic strategy, especially used for six-membered heterocyclic sulfinic acids, as has been published e.g. by Taylor et al. (Tetrahedron 23, 2081-2093 (1967)). For five and six membered heteroaromatic sulfinic acids, several oxidative methods have been published (Chem. Pharm. Bul. 36(7), 2652-2653 (1988); Helvetica Chimica Acta, 69(3), 708-717 (1986); Helcetica Chimica Acta, 69(5), 1095-1106 (1986); J. Med. Chem. 7(6), 792-799 (1964); Chem. Ber., 93, 1590-1597 (1960)). Addition of SO₂ to deprotonated heterocycles has also been described (J. Org. Chem. 56(13), 4260-4263 (1991)). It has advantageously been decided to take a synthetic approach making use of disproportionation of symmetrical disulfides in an alkaline medium, similar to the mechanisms proposed by Barton et al. (Tetrahedron Letters 31(7), 949-952 (1990)) for the carboxylate induced disproportionation of symmetrical disulfides.

It has further advantageously been decided to first prepare the symmetrical disulfides and to convert them, at least partially, into the sulfinic acid salts upon dissolving them in an alkaline medium. This has been illustrated for compound II-1 as given hereinafter.

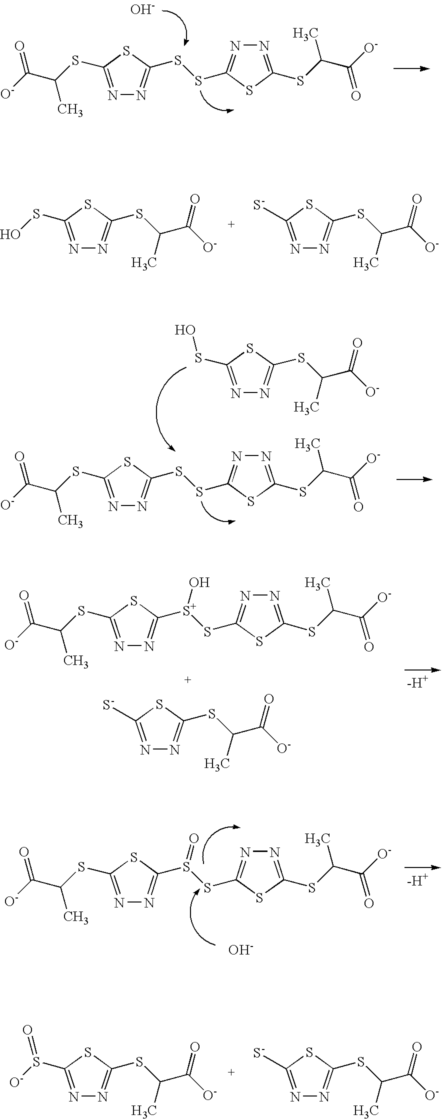

A mechanism, illustrative for the disproportionation reaction has been given in the next scheme hereinafter, omitting therein a potential carboxylate catalysis:

The aqueous solution obtained after dissolving the disulfide in alkaline medium was analysed with NMR and mass spectroscopy: both spectroscopic techniques were unambiguously confirming the composition as anticipated from the proposed mechanism.

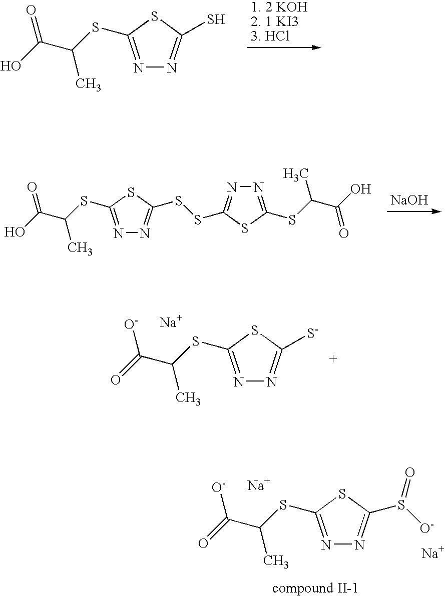

The solution can be used as such in photographic applications without isolating the sulfinic acid.

In a further preferred embodiment the said silver halide material comprises at least one heteroaromatic disulfide, in that in said compound according to general formula (I), X— is represented by a group according to general formula (III), 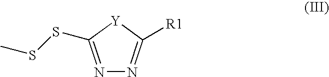
wherein Y and R1 are defined as in general formula (I).

Typical examples of compounds according to general formula (III) are given below, without being limited thereto.

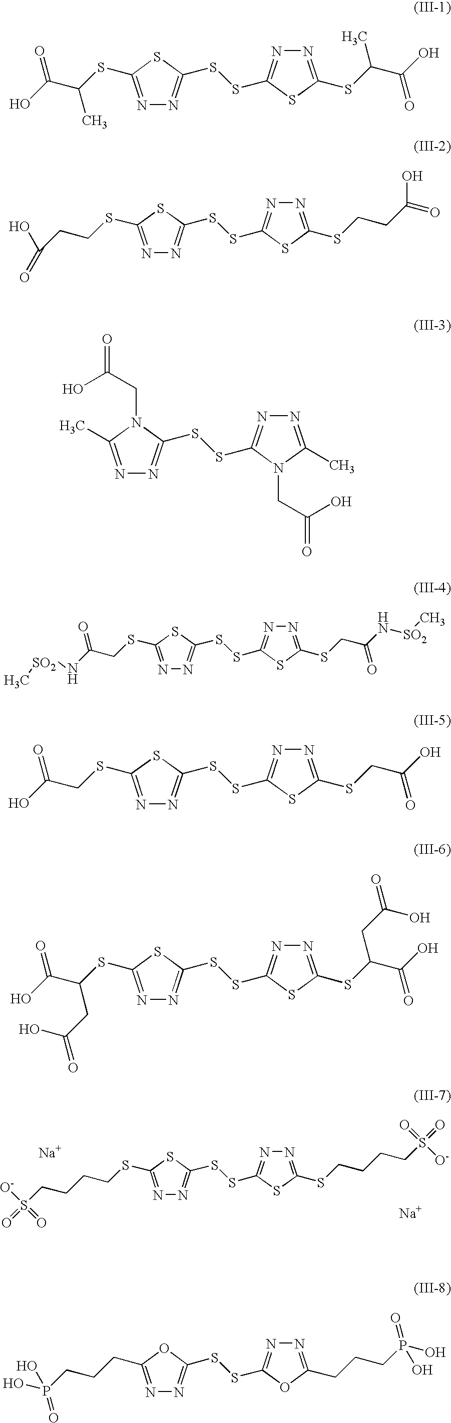

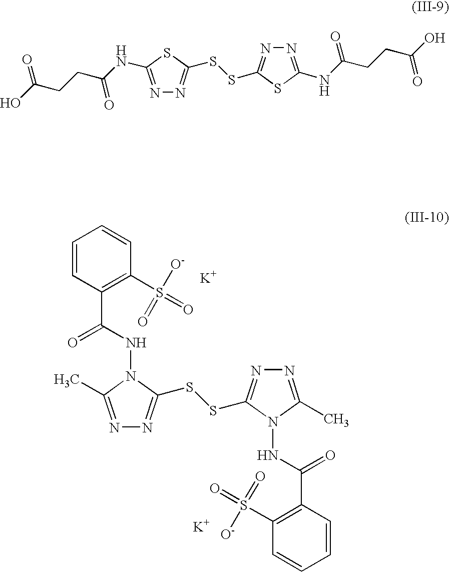

According to the present invention X in general formula (I) is therein advantageously obtained by the method of oxidation of the corresponding thiol or thiolate, so that X represents a functional group containing sulfur, apart from a thiol group or a thiolate.

According to the present invention in a silver halide photographic material as disclosed hereinbefore at least one of the compounds (I), (II) and (III) is present in the light-sensitive silver halide emulsion layer or in a layer adjacent thereto, in an amount from 10⁻⁶ to 10⁻¹ mol per mol of silver halide, more preferably from 10⁻⁴ to 10⁻¹ mol and even more preferably from 0.25 mmol to 10⁻¹ mol per mol of silver halide.

Furtheron according to the present invention a silver halide photographic material is provided, wherein the coating amount of the tabular silver halide grains, expressed as an equivalent amount of silver nitrate, is in a range of from 0.1 to 6 g/m².

According to the present invention a method is offered of preparing a silver halide photographic material by coating on a support at least one light-sensitive silver halide emulsion layer containing tabular silver halide grains having a thickness in the range from 0.05 μm up to 0.25 μm, wherein said grains having an aspect ratio in the range from 5:1 up to 50:1 represent a projective surface area of at least 50% of the total projected surface of all grains present, by adding to a coating solution, in water at ambient temperature, a solution of a heterocyclic disulfide according to formula (III) as disclosed hereinbefore, to which an equivalent amount of an inorganic base is added. In a more preferred embodiment said grains have a thickness in the range from 0.15 μm up to 0.25 μm, wherein said grains having an aspect ratio in the range from 8:1 up to 15:1 represent a projective surface area of at least 70% of the total projected surface.

In the layer arrangement used for the black-and-white silver halide negative working photographic material, on at least one side of a subbed support at least one light-sensitive layer is thus present, wherein said layer is sandwiched between an outermost non-light sensitive protective topcoat layer and an, optionally present, non-light sensitive intermediate layer coated onto the said subbed support.

In a preferred embodiment said film material is a radiographic single-side coated or double-side coated (also called “duplitized”) material.

The protective antistress layer(s) of the said radiographic material, according to the present invention, may be the outermost layers of the material, but an outermost afterlayer may optionally be present as disclosed e.g. in EP-A's 0 644 454 and 0 644 456, wherein e.g. a synthetic clay is present in favor of pressure resistance. Even a spray-coated layer may be present.

Moreover protective antistress layers may be coated as two adjacent layers, wherein, in one embodiment, preferably the layer coated adjacent to the emulsion layer should include at least one compound according to the formulae of a heteroatomic sulfinic acid compound, a disulfide compound or a combination thereof, wherein each of said compounds has a solubilizing group having a pKₐ-value of 10 or less as claimed. Protective antistress layers, besides their function as protection layer may include compounds providing better antistatic properties as has been disclosed e.g. in EP-A 0 644 454 (with polyoxyalkylene compounds as antistatic agents), in EP-A's 0 505 626, 0 534 006 and 0 644 456. As said layers are in most cases outermost layers, their contribution to satisfactory surface characteristics of the processed film material is very important, e.g. from the point of view of an excellent surface glare as desired by examining medecins, as has been described in EP-A's 0 806 705 and 0 992 845.

It has been established now that presence of one or more compounds satisfying the formulae (I) to (IV) in one or more non-light-sensitive layers (like the protective antistress layers and/or antihalation undercoat layers) adjacent to the light-sensitive silver halide emulsion layers of the (radiographic) material of the present invention further improves “image tone” in that a “colder” blue-black image is obtained as desired by medecins examining radiographs, for at least the same and even an increased covering power.

The light-sensitive (photosensitive) layers of the film material of the present invention coated on one or each of the major surfaces of the subbed support, thus contain chemically and spectrally blue-sensitized tabular grains having a thickness in the range from 0.05 μm up to 0.25 μm, wherein said grains having an aspect ratio in the range from 5:1 up to 50:1 represent a projective surface area of at least 50% of the total projected surface of all grains. More preferably said tabular grains are {111} tabular hexagonal silver halide emulsion grains or crystals rich in silver bromide in an amount covering at least 70%, and more preferably at least 90% of the total projective surface of all grains.

In a particular embodiment said grains are “core-shell” emulsion grains or crystals, wherein said grains are composed of a silver bromide core and a silver bromoiodide shell, and wherein an average amount over the whole crystal volume of more than 90 mole % of silver bromide is present, and an amount of from 0.05 up to 3.0 mole % (more preferably 0.05-2.0 and even more preferred 0.05 up to 0.5 mole %) of iodide, based on silver.

Average grain volumes can be determined from calculations, after measurement for each individual grain of its volume determined after having applied electrochemical reduction techniques, wherein electrical signals thus obtained are related with silver halide grain volumes after total reduction thereof to metallic silver at the cathode of an electrochemical cell. Percentages of the total projective area of all tabular grains with respect to the total projective area of all grains present in the emulsion layers are calculated from electron microscopic photographs (shadowed replicas). Average grain diameters and thicknesses of the tabular grains are calculated after determination of individual grain thickness and diameter, calculated as equivalent circular diameter of the hexagonal surface, from shadowed electron microscopic photographs or scanning electron microscopic photographs.

From the average ratios of (equivalent circular) diameter to thickness for each individual tabular grain aspect ratios are determined in order to get ability to further calculate the mean or average aspect ratio of the tabular grains in the emulsion distribution.

The negative-working black-and-white (radiographic) film material according to the present invention thus comprises light-sensitive layers at one or both sides of the film support wherein preferably {111} tabular silver halide grains rich in silver bromide (having at least 90 mole % of silver bromide, based on silver) and silver iodide in the limited amounts as set forth hereinbefore. Preparation methods for {111} tabular grain emulsions rich in silver bromide suitable for use with respect to tabular grains in materials of the present invention can be found in Research Dislosure No. 389057, p. 591-639 (1996), more particularly in Chapter I. A very useful method has e.g. been described in EP-A 0 843 208. Iodide ions added during precipitation, in a more preferred embodiment at the surface of al {111} tabular hexagonal grains, are provided in the preparation method by addition of an inorganic iodide salt as potassium iodide, thus causing conversion. More preferred as providing slower liberation of iodide in the reaction vessel is addition of organic agents releasing iodide ions in order to provide the low silver iodide concentrations, not exceeding 1 mole % and even more preferably not exceeding 0.5 mole %, based on silver and calculated as an average value over het whole grain volume. Addition of iodide by organic agents releasing iodide ions has been described e.g. in EP-A's 0 561 415, 0 563 701, 0 563 708 and 0 651 284 and in U.S. Pat. Nos. 5,482,826 and 5,736,312. In an alternative method iodide ions can be released from iodate as has been described in U.S. Pat. No. 5,736,312. Release of iodide in the presence of a compound adjusting the rate of iodide release can be applied as described in U.S. Pat. No. 5,807,663.

In another preferred embodiment addition of iodide to emulsion grains rich in silver bromide (having a preferred silver bromoiodide composition) is performed by adding fine preformed grains of silver iodide, whether or not including bromide (and/or, optionally, chloride in minor amounts), said grains having a grain diameter of not more than 100 nm, and, more preferably, not more than 50 nm. Such fine grains are so-called “Lippmann” emulsions. Addition of iodide making use from such fine grains rich in silver iodide (or even pure silver iodide) has been described for the preparation of {111} tabular grains in JP-A's 04-251241 and 08-029904 and in EP-A's 0 662 632 and 0 658 805, wherein an outermost phase rich in silver iodide has been added to {111} tabular grains rich in silver bromide (optionally comprising up to less than 10 mole % of silver chloride). Addition of fine AgI-Lippmann emulsions to the surface of the silver halide crystals in order to get a global iodide content in the range from 0.05 up to 0.5 mole % over the whole grain volume may advantageously proceed as disclosed in EP-A 0 475 191, wherein an excellent speed/fog ratio and a high covering power are attained.

The material according to the present invention invention thus has, in a preferred embodiment, silver halide grains composed of silver bromoiodide.

Preparation of the {111} tabular grain emulsions is performed in the presence of gelatin or colloidal silica sol as a binder providing colloidal stability during all preparation steps.

In one embodiment the precipitation of the tabular silver halide crystals is performed in the presence of a protective, hydrophilic colloid, as e.g. conventional lime-treated or acid treated gelatin, but also oxidized gelatin (see e.g. EP-A 0 843 208, which is incorporated herein by reference) or a synthetic peptizer may be used. As a result tabular grains in the light-sensitive silver halide emulsion layer are dispersed in a hydrophilic polymeric vehicle mixture comprising at least 0.5% of oxidized gelatin, based on the total dry weight of said polymeric vehicle mixture, i.a. about 2% and even up to about 4%. The preparation of such modified gelatin types has been described in e.g. “The Science and Technology of Gelatin”, edited by A. G. Ward and A. Courts, Academic Press 1977, page 295 and next pages. The gelatin can also be an enzyme-treated gelatin as described in Bull. Soc. Sci. Phot. Japan, No. 16, page 30 (1966). Before and during the formation of the silver halide grains it is common practice to establish a gelatin concentration of from about 0.05% to 5.0% by weight in the dispersion medium.

In another embodiment tabular silver halide grains used in emulsions according to the present invention are precipitated in the absence of gelatin by using colloidal silica sol as a protective colloid in the presence of an onium compound, preferably a phosphonium compound, as has been described in EP-A 0 677 773.

In order to control the grain size, beside dyes (even spectral sensitizing dyes e.g.) or crystal habit modifiers, other grain growth restrainers or accelerators may also be used during the precipitation, together with the flow rate and/or concentration variations of the silver and halide salt solutions, the temperature, pAg, physical ripening time, etc. Silver halide solvents such as ammonia, a thioether compound, thiazolidine-2-thione, tetra-substituted thiourea, potassium or ammonium rhodanide and an amine compound may be present during grain precipitation in order to further adjust the average grain size.

At the end of the precipitation the emulsion is made free from excess of soluble inorganic salts by a conventional washing technique e.g. flocculation by ammonium sulphate or polystyrene sulphonate, followed by one or more washing and redispersion steps. Another well-known washing technique is ultrafiltration or diafiltration. Finally, extra gelatin is added to the emulsion in order to obtain a gelatin to silver ratio which is optimized with respect to the coating conditions and/or in order to establish the required thickness of the coated emulsion layer. Preferably a gelatin to silver halide weight ratio ranging from 0.3 to 1.0 is then obtained.

It is clear that {111} tabular silver halide emulsion grains, present in light-sensitive emulsion layers of materials according to the present invention, are, besides spectrally sensitized in the blue wavelength range below 500 nm up to the near ultraviolet wavelength range, and more preferably in the range below 480 nm and even below 420 nm up to 300 nm, also chemically sensitized, at least with a combination of labile chalcogen compounds and gold compounds, more preferably with compounds providing sulphur, selenium (without even excluding tellurium) and gold. Chemical sensitization methods for {111} tabular grain emulsions rich in silver bromide can be found in Research Dislosure No. 389057, p. 591-639 (1996), more particularly in Chapter IV. Very useful methods related therewith have been disclosed in EP-A's 0 443 453, 0 454 069, 0 541 104 and in U.S. Pat. Nos. 5,112,733 and 5,654,134. Useful labile selenium compounds have been disclosed in EP-A's 0 831 363, 0 889 354 and 0 895 121. Said labile selenium compounds are commonly applied in combination with sulphur and gold, and so are labile tellurium compounds as has been disclosed e.g. in EP-A 1 070 986.

Preparation of spectrally and chemically sensitized tabular grains as may be applied to emulsion grains to be coated light-sensitive layers of a radiographic material according to the present invention by performing spectral sensitization before chemical sensitization, so that the spectral sensitizer acts as a site-director for the sensitivity specks, generated during chemical sensitization. A broad review about spectral sensitization can be found in in Research Dislosure No. 389057, p. 591-639 (1996), more particularly in Chapter V. Further useful information about additives which may be used in order to prepare emulsions to be coated in a material according to the present invention can be found in Research Disclosure No. 389057, p. 591-639 (1996), as in Chapter VII about antifoggants and stabilizers, in Chapter VIII about coating physical property modifying addenda, in Chapter XI about layer arrangements and in Chapter XV about supports.

Said light-sensitive layers present in the material according to the present invention further comprise, in one embodiment, an emulsion having {111} hexagonal tabular silver bromoiodide grains, spectrally sensitive to irradiation in the wavelength range shorter than 420 nm by the presence of at least one J-aggregating zeromethine blue spectral sensitizer (preferred sensitizers have been given in EP-A's 0 712 034 and 1 045 282). Moreover at least one dye selected from the group consisting of azacyanine dyes and monomethine cyanine dyes, as further disclosed in the already cited EP-A 1 045 282 may advantageously be present. So the material according to the present invention has grains which have thus been made sensitive to the ultraviolet and/or blue range of the wavelength spectrum, wherein the blue/ultraviolet absorbing dye combination of zeromethine dyes, optionally with monomethine or azacyanine sensitizing dyes absorbing blue/UV-radiation as described in EP-A 1 045 282 may be suitable for use when the radiographic material according to the present invention is applied in combination with a blue/UV-intensifying screen. Besides the favorable diagnostic value with respect to image quality thanks to a low fog level, a high overall contrast, an enhanced sharpness (low cross-over percentage, better than in the green sensitized materials and not requiring use of antihalation dyes in the undercoat between emulsion layer and support), absence of residual color, even in rapid processing cycles, and a particularly good image tone, excellent preservation of sensiometric characteristics of the materials is provided, according to the objects of the present invention.

Said blue-sensitizing dye or dyes are added as first dye during the chemical ripening procedure, before addition of the chemical ripening compounds or agents. Mixtures of blue sensitizing dyes are particularly interesting from the point of view of an increased spectral response in form of speed, which can be achieved at lower total amounts of dyes as becomes clear from U.S. Pat. No. 5,707,794.

Duplitized film materials (defined as materials having radiation-sensitive emulsions layers, coated at both sides of the material support), particularly suitable for use in radiographic applications, are irradiated by the light emitted imagewise by X-ray intensifying screens after conversion of X-ray radiation to the said light by luminescent phosphors coated in the said screens or panels, in intimate contact therewith at both sides of the coated film support during X-ray exposure of part of a patient. A diagnostic silver image, in conformity with the X-ray image, is obtained after processing of the said film material. During X-ray exposure irradiation of said film is arranged in a cassette between two X-ray intensifying screens each of them making contact with its corresponding light-sensitive side, thus forming a film/screen system. In another embodiment said film is in contact with one single X-ray intensifying screen in case of a single-side coated radiographic material.

In one embodiment according to the present invention a radiographic screen/film combination or system has been provided comprising a duplitized film material, sandwiched between a pair of supported or self-supporting X-ray intensifying screens, characterized in that
i) said pair of supported or self-supporting X-ray intensifying screens essentially consists of luminescent phosphor particles emitting at least 50% and more preferably at least 80% of their emitted radiation in the wavelength range shorter than 500 nm and even more preferred below 420 nm,
   as e.g. a niobium and gadolinium doped, monoclinic M, yttriumtantalate (MYT) phosphor or a calcium tungstate phosphor;
ii) said film comprises {111} tabular silver halide grains rich in silver bromide, spectrally sensitive to irradiation in the said wavelength range shorter than 420 nm by the presence of at least one J-aggregating blue spectral sensitizer (e.g. a zeromethine sensitizer as disclosed in EP-A 0 712 034) and of at least one of the non-J-aggregate forming dyes selected from the group consisting of azacyanine dyes and monomethine cyanine dyes (as disclosed in EP-A 1 045 282) respectively, mentioned hereinbefore in the description, wherein said emulsion is present in at least one light-sensitive emulsion layer on at least one side of the film support of the radiographic material of the present invention.

In the context of the present invention, more particularly with respect to the purposes to get reduced dye stain, also called residual color, and an excellent image tone, said reduced dye stain delivering an indispensible asset thereto, azacyanine dyes may advantageously be used in the preparation of {111} tabular grain emulsions as the presence of said dyes permits further addition of J-aggregating spectral sensitizers in lower amounts, without loss in speed, thereby providing better decoloration in the processing. A survey of other useful chemical classes of J-aggregating spectral sensitizers suitable for use in spectrally sensitizing emulsions of the present invention has been described by F. M. Hamer in “The Cyanine Dyes and Related Compounds”, 1964, John Wiley & Sons and other examples specifically useful for spectral sensitization of tabular grains have been given in Research Disclosure Item 22534 and in addition a more recent overview has been given in EP-A 0 757 285, wherefrom dyes forming J-aggregates on the flat surface of the preferred silver bromide or silver bromoiodide crystals are particularly useful.

Other dyes, which per se do not have any spectral sensitization activity, or certain other compounds, which do not substantially absorb visible radiation, can have a supersensitization effect when they are incorporated together with said spectral sensitizing agents into the emulsion. Suitable supersensitizers are, i.a. heterocyclic mercapto compounds containing at least one electronegative substituent as described e.g. in U.S. Pat. No. 3,457,078, nitrogen-containing heterocyclic ring-substituted aminostilbene compounds as described e.g. in U.S. Pat. Nos. 2,933,390 and 3,635,721, aromatic organic acid/formaldehyde condensation products as described e.g. in U.S. Pat. No. 3,743,510 as well as cadmium salts and azaindene compounds.

The silver halide emulsions used in light-sensitive layers of the material according to the present invention may also comprise compounds preventing the formation of a high minimum density or stabilizing the photographic properties during the production or storage of photographic materials or during the photographic treatment thereof. Many known compounds can be added as fog-inhibiting agent or stabilizer to the silver halide emulsion. Suitable examples are i.a. the heterocyclic nitrogen-containing compounds such as benzothiazolium salts, nitroimidazoles, nitrobenzimidazoles, chlorobenzimidazoles, bromobenzimidazoles, mercaptothiazoles, mercaptobenzothiazoles, mercaptobenzimidazoles, mercaptothiadiazoles, aminotriazoles, benzotriazoles (preferably 5-methyl-benzotriazole), nitrobenzotriazoles, mercaptotetrazoles, in particular 1-phenyl-5-mercapto-tetrazole, mercaptopyrimidines, mercaptotriazines, benzothiazoline-2-thione, oxazoline-thione, triazaindenes, tetrazaindenes and pentazaindenes, especially those described by Birr in Z. Wiss. Phot. 47 (1952), pages 2-58, triazolopyrimidines such as those described in GB-A 1,203,757, GB-A 1,209,146, JP-B 77/031738 and GB-A 1,500,278, and 7-hydroxy-s-triazolo-[1,5-a]-pyrimidines as described in U.S. Pat. No. 4,727,017, and other compounds such as benzenethiosulphonic acid, benzenethio-sulphinic acid and benzenethiosulphonic acid amide.

Other compounds which can be used as fog-inhibiting compounds are those described in Research Disclosure No. 17643 (1978), Chaptre VI. These fog-inhibiting agents or stabilizers can be added to the silver halide emulsion prior to, during, or after the ripening thereof and mixtures of two or more of these compounds can be used.

The binder of the layers, especially when gelatin is used as a binder, can be forehardened with appropriate hardening agents such as those of the epoxide type, those of the ethylenimine type, those of the vinylsulfone type, e.g. 1,3-vinylsulphonyl-2-propanol or di-(vinylsulphonyl)-methane, vinylsulphonyl-ether compounds, vinylsulphonyl compounds having soluble groups, chromium salts like e.g. chromium acetate and chromium alum, aldehydes as e.g. formaldehyde, glyoxal, and glutaraldehyde, N-methylol compounds as e.g. dimethylolurea and methyloldimethylhydantoin, dioxan derivatives e.g. 2,3-dihydroxy-dioxan, active vinyl compounds e.g. 1,3,5-triacryloyl-hexahydro-s-triazine, active halogen compounds e.g. 2,4-dichloro-6-hydroxy-s-triazine, and mucohalogenic acids e.g. mucochloric acid and mucophenoxychloric acid. These hardeners can be used alone or in combination. The binder can also be hardened with fast-reacting hardeners such as carbamoylpyridinium salts as disclosed in U.S. Pat. No. 4,063,952 and with the onium compounds as disclosed in EP-A 0 408 143.

The photographic material according to the present invention may further comprise various kinds of surface-active agents in the light-sensitive emulsion layer(s) or in at least one other hydrophilic colloid layer. Suitable surface-active agents include non-ionic agents such as saponins, alkylene oxides, e.g., polyethylene glycol, polyethylene glycol/polypropylene glycol condensation products, polyethylene glycol alkyl ethers or polyethylene glycol alkylaryl ethers, polyethylene glycol esters, polyethylene glycol sorbitan esters, polyalkylene glycol alkylamines or alkylamides, silicone-polyethylene oxide adducts, glycidol derivatives, fatty acid esters of polyhydric alcohols and alkyl esters of saccharides, anionic agents comprising an acid group such as a carboxyl, sulpho, phospho, sulphuric or phosphoric ester group; ampholytic agents such as aminoacids, aminoalkyl sulphonic acids, aminoalkyl sulphates or phosphates, alkyl betaines, and amine-N-oxides; and cationic agents such as alkylamine salts, aliphatic, aromatic, or heterocyclic quaternary ammonium salts, aliphatic or heterocyclic ring-containing phosphonium or sulphonium salts. Such surface-active agents can be used for various purposes, e.g. as coating aids, as compounds preventing electric charges, as compounds improving film transport in automatic film handling equipment, as compounds facilitating dispersive emulsification, as compounds preventing or reducing adhesion, and as compounds improving photographic properties such as higher contrast, sensitization and development acceleration. Especially when rapid processing conditions are important, development acceleration may be useful, which can be accomplished with the aid of various compounds, preferably polyoxyalkylene derivatives having a molecular weight of at least 400 such as those described in e.g. U.S. Pat. Nos. 3,038,805; 4,038,075 and 4,292,400. Especially preferred developing accelerators are recurrent thioether groups containing polyoxyethylenes as described in DE 2,360,878, EP-A's 0 634 688 and 0 674 215. The same or different or a mixture of different developing accelerators may be added to at least one of the hydrophilic layers at the emulsion side. It may be advantageous to partially substitute the hydrophilic colloid binder, preferably gelatin, of the light-sensitive silver halide emulsion layer or of an hydrophilic colloid layer in water-permeable relationship therewith by suitable amounts of dextran or dextran derivatives to improve the covering power of the silver image formed and to provide a higher resistance to abrasion in wet condition.

The photographic material of the present invention may further comprise various other additives such as compounds improving the dimensional stability of the photographic material, UV-absorbers, spacing agents, lubricants, plasticizers, antistatic agents, etc. Suitable additives for improving the dimensional stability are i.a. dispersions of a water-soluble or hardly soluble synthetic polymer e.g. polymers of alkyl(meth)acrylates, alkoxy(meth)acrylates, glycidyl(meth)acrylates, (meth)acrylamides, vinyl esters, acrylonitriles, olefins and styrenes, or copolymers of the above with acrylic acids, methacrylic acids, α-β-unsaturated dicarboxylic acids, hydroxyalkyl(meth)acrylates, sulphoalkyl(meth)acrylates, and styrene sulphonic acids. Suitable UV-absorbers are e.g. aryl-substituted benzotriazole compounds as described in U.S. Pat. No. 3,533,794, 4-thiazolidone compounds as described in U.S. Pat. Nos. 3,314,794 and 3,352,681, benzophenone compounds as described in JP-A 2784/71, cinnamic ester compounds as described in U.S. Pat. Nos. 3,705,805 and 3,707,375, butadiene compounds as described in U.S. Pat. No. 4,045,229, and benzoxazole compounds as described in U.S. Pat. No. 3,700,455.

In general, the average particle size of spacing agents is comprised between 0.2 and 10 μm. Spacing agents can be soluble or insoluble in alkali. Alkali-insoluble spacing agents usually remain permanently in the photographic material, whereas alkali-soluble spacing agents usually are removed in an alkaline processing bath. Suitable spacing agents can be made i.a. of polymethyl methacrylate, of copolymers of acrylic acid and methyl methacrylate, and of hydroxypropylmethyl cellulose hexahydrophthalate. Other suitable spacing agents have been described in U.S. Pat. No. 4,614,708.

Compounds which can be used as a plasticizer for the hydrophilic colloid layers are acetamide or polyols such as trimethylolpropane, pentanediol, butanediol, ethylene glycol and glycerine. Further, a polymer latex is preferably incorporated into the hydrophilic colloid layer for the purpose of improving the anti-pressure properties, e.g. a homopolymer of acrylic acid alkyl ester or a copolymer thereof with acrylic acid, a copolymer of styrene and butadiene, and a homopolymer or copolymer consisting of monomers having an active methylene group.

The photographic material according to the present invention may comprise an antistatic layer to avoid static discharges during coating, processing and other handling of the material. Such antistatic layer may be an outermost coating like the protective layer or an afterlayer or a stratum of one or more antistatic agents or a coating applied directly to the film support or other support and overcoated with a barrier or gelatin layer. Antistatic compounds suitable for use in such layers are e.g. vanadium pentoxide soles, tin oxide soles or conductive polymers such as polyethylene oxides (see e.g. EP-A 0 890 874) or a polymer latex and the like or polymers providing permanent antistatic properties as polyethylene dioxythiophenes (PEDT) described e.g. in U.S. Pat. Nos. 5,312,681; 5,354,613 and 5,391,472; and in EP-A 1 031 875.

According to the present invention a method of image formation is further advantageously applied by consecutively performing the steps of exposing to X-rays the radiographic screen/film combination or system described hereinbefore; followed by processing the film according to the present invention by the steps of developing, fixing, rinsing and drying.

The said processsing is preferably performed in an automatic processsing machine. More in detail for processing the film material of the present invention, preferably an automatically operating apparatus is used provided with a system for automatic replenishment of the processing solutions. The processing dry-to-dry within a short processing time of from 30 to 90 seconds and more preferably from 30 seconds to less than 60 seconds of materials coated from low amounts of silver is made possible by the steps of developing said material in a developer (preferably) without hardening agent; fixing said material in a fixer, optionally without hardening agent; rinsing and drying said material.

A normally used configuration in the processing apparatus shows the following consecutive tank units corresponding with, as consecutive solutions: developer-fixer-rinse water. Recent developments however have shown, that from the viewpoint of ecology and especially with respect to reduction of replenishing amounts, as consecutive solutions the sequence developer-fixer-fixer-rinse water-rinse water is preferred. One washing step between developing and fixation and one at the end before drying may als be present. As ecology and low replenishing amounts are main topics with respect to the present invention use is made of concentrated hardener free processing solutions in one single package. Examples thereof have been disclosed e.g. in U.S. Pat. Nos. 5,187,050 and 5,296,342.

Especially preferred developers comprising ecologically acceptable developing agents such as ascorbic acid and derivatives thereof have been described in EP-A 0 732 619 and in U.S. Pat. Nos. 5,593,817 and 5,604,082. Instead of or partially substituting (e.g. in a ratio by weight of from 1:1 up to 9:1) the ecologically questionable “hydroquinone” (iso)ascorbic acid, 1-ascorbic acid and tetramethyl reductic acid are preferred as main developing agent in the developer. Said developing agents which are especially suitable for use, have further been described in EP-A's 0 461 783, 0 498 968, 0 690 343, 0 696 759, 0 704 756, 0 732 619, 0 731 381 and 0 731 382; in U.S. Pat. Nos. 5,474,879 and 5,498,511 and in Research Disclosure No 371052, published Mar. 1, 1995, wherein a more general formula covering the formula of said developing agents has been represented.

In order to reduce “sludge formation” which is favored by solubilizing agents like sulphites, present in the developer as preservatives, a particularly suitable developer solution is the one comprising a reduced amount of sulphite and ascorbic acid which acts as a main developer and anti-oxidant as well and which is called “low-sludge” developer. Suitable measures taken therefore have recently been described in the EP-A's 1 061 413 and 1 061 414.

Processing cycles wherein no boron compounds are used, are particularly interesting from an ecological point of view as has been described in EP-A 0 908 764 and the corresponding U.S. Pat. No. 6,083,672. So in favor of ecological fixation presence of aluminum ions should be reduced, and more preferably, no aluminum ions should be present. This is moreover in favor of the absence of “sludge” formation, a phenomenon which leads to pi-line defects when high amounts of silver are coated in the light-sensitive layers. Measures in order to reduce “sludge-formation” have further been described in U.S. Pat. Nos. 5,447,817; 5,462,831 and 5,518,868. A particularly suitable fixer solution comprises an amount of less than 25 g of potassium sulphite per liter without the presence of acetic acid wherein said fixer has a pH value of at least 4.5, in order to make the fixer solution quasi odorless. If however aluminum ions are present in the fixer composition for whatever a reason, the presence of α-ketocarboxylic acid compounds is recommended as has been described in EP-A's 0 620 483 and 0 726 491 as well as in RD 16768, published March 1978. It is possible to use sodium thiosulphate as a fixing agent, thus avoiding the ecologically undesirable ammonium ions normally used. For low coating amounts of emulsion crystals rich in chloride a fixation time which is reduced to about 2 to 10 seconds can be attained. Moreover regeneration is kept to a minimum, especially in the processing of materials coated with reduced amounts of silver halide as in the present invention.

As already set forth hereinbefore single-side coated materials are also envisaged in the present invention, such as in combination with a single screen having luminescent phosphors with a high prompt emission of fluorescent light on X-ray irradiation and low afterglow in favor of image sharpness, suitable for use in mammography, wherefore the relationship between resolution and speed of X-ray intensifying screens has been described e.g. in Med. Phys. 5(3), 205 (1978).

Other single-side coated materials wherein the emulsions can advantageously applied, e.g. with respect to preservation properties, developability, etc. are black-and-white silver halide material used e.g. in micrography, in aviation photography, in black-and-white cinefilms, in laserfilms or hardcopy films and in graphic or reprographic applications.

### EXAMPLES

While the present invention will hereinafter be described in connection with preferred embodiments thereof, it will be understood that it is not intended to limit the invention to those embodiments.

Preparation of the Tabular Grain Emulsion.

To a solution of 6.0 g of gelatin and 36 ml of a 2.96 molar solution of potassium bromide in 2127 ml of demineralized water at 51° C., stirred up to a rate of 150 r.p.m., were added by double jet addition aqueous solutions of 1.96 molar of silver nitrate (solution A1) and 1.96 molar of potassium bromide (solution B1): 18.2 ml of A1 and 18.2 ml of B1 were added within a time interval of 35 seconds. When the addition was completed, the temperature was increased up to 70° C. over a period of 19.5 minutes: UAg was controlled (expressed in mV) versus a Ag/AgCl (saturated) reference electrode and should be in the range from 18±5 mV at a temperature of 70±1° C. 30 seconds later a solution of 47.5 g of inert gelatin in 475 ml of demineralized water of 55° C. were added. 3 minutes later the stirring rate was increased from 15 r.p.m. up to 400 r.p.m. and after 1 minute the stirring rate was linearly increased from 400 r.p.m. up to 550 r.p.m. until the end of the precipitation.

2 minutes later A1 was added at a constant rate of 5.0 ml/min. during 133 seconds. In a further double jet precipitation step A1 and B1 were added during 4430 seconds at a linearly increasing rate going from 5.0 up to 10.26 ml/min. for solution A1 and from 5.12 up is to 10.50 ml/min. for B1 in order to maintain a constant UAg potential of −2 mV in the reaction vessel.

After 5 minutes grain growth was performed in a second growth step by addition of solution A1 at a constant rate of 5.0 ml/min. during 550 seconds. In a further double jet addition A1 and B2 (a 571 ml aqueous solution of 2.96 molar of potassium bromide, where 1.045 ml of a 2.96 molar solution of potassium iodide has been added) were added during 4358 seconds at a linearly increasing rate going from 5.0 up to 18.93 ml/min. for A1 and from 3.32 up to 12.56 ml/min. for B2 in order to maintain a constant UAg potential of 90 mV in the reaction vessel. After this double-jet addition period, at the end of the precipitation, an emulsion having silver bromoiodide tabular grains having iodide present in an amount of 0.1 mol %, based on silver, was obtained.

The average grain size of the silver bromoiodide tabular {111} grains thus prepared, expressed as equivalent volume diameter, was 0.85 μm, with an average thickness of 0.230 μm.

Next the pH value of the dispersing medium was adjusted to a value of 3.5 with diluted sulphuric acid and the obtained flocculate was decanted to a volume of 1.2 liter, washed twice with an amount of 4.15 l of demineralized water of 11° C., in order to remove soluble salts present.

After washing, peptization was performed by addition of gelatin and water in order to obtain a silver halide content of 211 g/kg (expressed as equivalent amount of silver nitrate) and a gelatin content of 93.2 g.

To the emulsion having a weight of 2367 g, pH of which was adjusted to 6.0, were consecutively added: 2.38 ml of a 10 wt % KSCN solution, followed y addition, after 5 minutes, of 219 ml of a 0.4 wt % of solution of the dye, the formula of which has been given hereinafter:

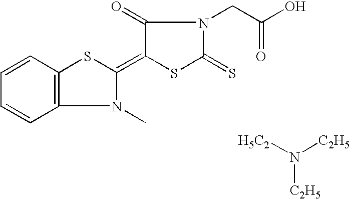

Addition of the said dye was followed by a digestion time of 30 minutes, and after that time 2.47 ml of sodium thiosulfate, dissolved in 10 ml of demineralized water at 35° C., were added, followed after 3 minutes by addition of 6.34 ml of a solution containing 9.889 mmol per liter of chloro auric acid and 15.8 mmol per liter of an aqueous solution of ammonium rhodanide. Finally after 5 minutes 10 ml of a 1 wt % of a solution of 1-(p-carboxyphenyl)-5-mercaptotetrazole.

The emulsion sample was chemically ripened at 52° C. during a time in order to obtain an optimal fog-sensitivity relationship. After cooling phenol was added as a preservation agent.

Coating of the Materials

Preparation of the Film Material.

In order to prepare the coating composition of the light-sensitive silver halide emulsion layer, wherein an average total amount of 7.4 g of silver nitrate per m² were coated.

As stabilizers in the emulsion layer coatings 0.2 mmole of 1-(m-carboxymethylthioacetamido)-phenyl-5-mercaptotetrazole and 0.6 mmole of 5-methyl-1,2,4-triazolo-(1,5-A)-pyrimidine-7-ol were added per mol of silver. Resorcinol was further added as hardener stabilizer in an amount of 2.8 g per mole of Ag. Consecutively 0.1 g of polyglycol (MW=8000) was added as a development accelerator, 5 ml of polyoxyethylene surfactant H₁₇C₈-Phenyl-(O—CH₂—CH₂)₈—O—CH₂—COOH and in an amount of 195 mg (per mole of Ag) fluoroglucinol was added as a hardener accelerator together with polyethyl acrylate latex (in an amount of 14.1 g/mol of silver).

Following addenda were further added:

18 ml of a 500 g/l solution of acetamide, used as a softening agent for gelatin, in order to get 9 g/mol of silver coated;
3 ml of a 10 g/l of a stabilizer, the formula of which is 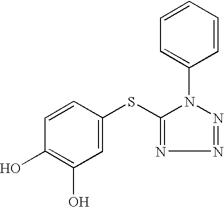
given hereinafter, in order to get 0.03 g/mol of silver coated;
9 ml of a 50 g/l of an activator, the formula of which is given hereinafter, in order to get 0.45 g/mol of silver coated; 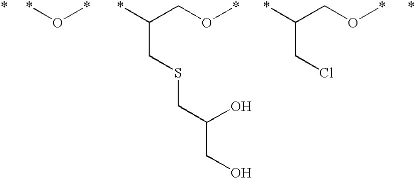
44 ml of a 200 g/l of a development accelerator, the formula of which is given hereinafter, in order to get 8.8 g/mol of silver coated;

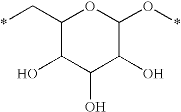

Following protective layer was coated thereupon (pH value: 6.10) at both sides:

Composition of the protective antistress layer

| | | |
|---|---|---|
| Gelatin | 1.10 | g/m² |
| Graft copolymer (1) | 21 | mg/m² |
| Chromium acetic acid | 7.1 | mg/m² |
| Compound (2) | 10.1 | mg/m² |
| Compound (3) | 5.1 | mg/m² |
| Mobilcer Q | 0.25 | ml/m² |
| (MMM trademarked product) | | |
| Compound (4) | 39.3 | mg/m² |
| Compound (5) | 2.1 | mg/m² |

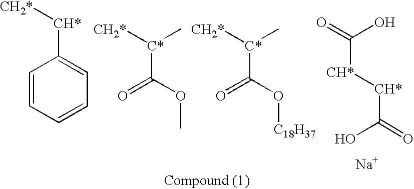

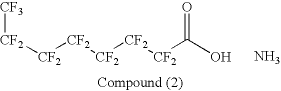

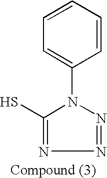

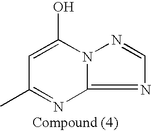

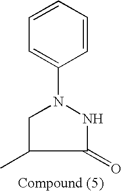

The solutions for the emulsion coating and for the protective coating were coated simultaneously on both sides of a polyethylene terephthalate film support having a thickness of 168 μm and an optical density of 0.160.

Samples of these coatings were exposed to visible light through a “Corning filter 5850” as a blue filter, during 0.1 second, making use of a continues wedge and were processed.

The processing was run in the developer G138i®, followed by fixing in the fixer G334i®, all of them being trademarketed products from Agfa-Gevaert N. V., Mortsel, Belgium, followed by rinsing at the indicated temperature of 33° C. for a total processing time of 90 seconds.

Following Parameters are Given in the Table 1:
Fog “F”, given as an integer after having multiplied the real fog density as measured with a factor of 1000;
Speed “S”, given as an integer after having multiplied the sensitivity measured at a density of 1.00 above minimum density as measured with a factor of 100;—an decrease of speed with a figure of 30 corresponding with a doubling in speed—;
Gradation (contrast) “GG”, given as an integer after having multiplied with a factor of 100 the real gradation—contrast—figure as measured between a density of 0.25 and 2.0 above minimum density;
Density latitude “DLT”, given as maximum density as measured after subtraction of the density of the support, multiplied with a factor of 100 and a measure for covering power—as coating amounts of silver halide were approximately the same.
Differences in speed “ΔS”: fresh material versus material having been stored for 4 days at 45° C. at 70% RV.
Percentage of “contrast reduction” “% CR”, after storage during 4 days at 70% RV, wherein said “contrast” was measured as an average gradient in the density range between 0.25 and 2.00 above minimum density.

A compound (cpd) according to the formula (III-1) was added to the emulsion layer and expressed in mg/m² in Table 1 hereinafter.

TABLE 1

| Matl. No | cpd | F | S | GG | DLT | ΔS | % CR |
|---|---|---|---|---|---|---|---|
| 1 (comp) | 0 | 196 | 156 | 298 | 417 | −35 | −30 |
| 2 | 1.5 | 191 | 157 | 304 | 413 | −15 | −20 |
| 3 | 3.0 | 191 | 158 | 304 | 416 | +3 | −10 |
| 4 | 4.5 | 193 | 158 | 304 | 412 | +5 | −9 |

As becomes clear from the Table 1 for an almost unchanged fog, speed, contrast and density latitude, a remarkably lower loss of speed and contrastr reduction was attained after preservation of the material before exposure, as soon as an amount of compound (III-1) of from 3.0 mg/m² or more was added to the emulsion layer. This corresponds with an amount of about 250 μmole per mole of silver (halide).

Having described in detail preferred embodiments of the current invention, it will now be apparent to those skilled in the art that numerous modifications can be made therein without departing from the scope of the invention as defined in the appending claims.▪

1. A black-and-white silver halide negative working photographic material, spectrally sensitized in the wavelength range below 500 nm, wherein at least one light-sensitive emulsion layer thereof comprises tabular grains having a thickness in the range from 0.05 μm up to 0.25 μm, wherein said grains having an aspect ratio in the range from 5:1 up to 50:1 represent a projective surface area of at least 50% of the total projected surface of all grains present in the emulsion and wherein said material comprises at least one compound according to general formula (I) 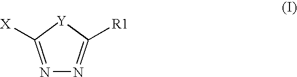
wherein:
X represents a functional group containing sulfur, apart from a thiol group or a thiolate;
Y is selected from the group consisting of an oxygen atom, a sulfur atom, NR², NNR³R⁴ and N—N═CR⁵R⁶
R¹ is selected from the group consisting of hydrogen, a heteroatomic group, an aryl or heteroaryl group, S—R⁷ and NR⁸R⁹;
R², R⁵, R⁶ and R⁷ are selected from the group consisting of hydrogen, an aliphatic or heteroatomic group, an aryl or heteroaryl group;
R³, R⁴, R⁸ and R⁹ are selected from the group consisting of hydrogen, an aliphatic or heteroatomic group; an aryl or heteroaryl group, an acyl group, a sulphonyl group and a phosphoryl group; wherein any of R³ and R⁴, R⁵ and R⁶, R⁸ and R⁹ may represent atoms necessary to form a five to eight membered, and wherein R¹ and Y may form a five to eight membered ring, further characterized in that at least one of Y and R¹ is substituted by a solubilizing group having a pKₐ of 10 or less.

2. A silver halide material according to claim 1, wherein in said compound according to general formula (I), X— is represented by a group according to formula (II), 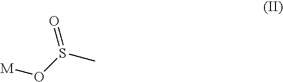
wherein M represents a hydrogen atom or a counterion.

3. A silver halide material according to claim 1, wherein in said compound according to general formula (I), X— is represented by a group according to formula (III), 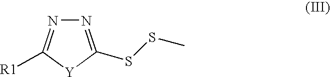
wherein Y and R¹ are defined in formula (III) as in claim 1.

4. A silver halide photographic material according to claim 1, wherein said material further comprises a compound according to general formula (IV), 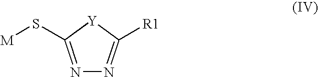
wherein Y and R1 are defined as in claim 1 and M represents a hydrogen atom or a counterion.

5. A silver halide photographic material according to claim 2, wherein said material further comprises a compound according to general formula (IV), 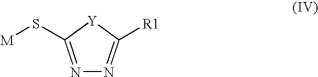
wherein Y and R1 are defined as in claim 1 and M represents a hydrogen atom or a counterion.

6. A silver halide photographic material according to claim 3, wherein said material further comprises a compound according to general formula (IV), 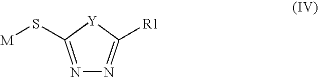
wherein Y and R1 are defined as in claim 1 and M represents a hydrogen atom or a counterion.

7. A silver halide photographic material according to claim 1, wherein said solubilizing group is selected from the group consisting of a carboxylic acid or salt thereof, a sulfonic acid or salt thereof, a phosphonate, a phosphate, a sulfate and an acylsulfonamide or salt thereof.

8. A silver halide photographic material according to claim 2, wherein said solubilizing group is selected from the group consisting of a carboxylic acid or salt thereof, a sulfonic acid or salt thereof, a phosphonate, a phosphate, a sulfate and an acylsulfonamide or salt thereof.

9. A silver halide photographic material according to claim 3, wherein said solubilizing group is selected from the group consisting of a carboxylic acid or salt thereof, a sulfonic acid or salt thereof, a phosphonate, a phosphate, a sulfate and an acylsulfonamide or salt thereof.

10. A silver halide photographic material according to claim 4, wherein said solubilizing group is selected from the group consisting of a carboxylic acid or salt thereof, a sulfonic acid or salt thereof, a phosphonate, a phosphate, a sulfate and an acylsulfonamide or salt thereof.

11. A silver halide photographic material according to claim 5, wherein said solubilizing group is selected from the group consisting of a carboxylic acid or salt thereof, a sulfonic acid or salt thereof, a phosphonate, a phosphate, a sulfate and an acylsulfonamide or salt thereof.

12. A silver halide photographic material according to claim 6, wherein said solubilizing group is selected from the group consisting of a carboxylic acid or salt thereof, a sulfonic acid or salt thereof, a phosphonate, a phosphate, a sulfate and an acylsulfonamide or salt thereof.

13. A silver halide photographic material according to claim 1,
wherein Y is a sulfur atom.

14. A silver halide photographic material according to claim 2,
wherein Y is a sulfur atom.

15. A silver halide photographic material according to claim 3,
wherein Y is a sulfur atom.

16. A silver halide photographic material according to claim 4,
wherein Y is a sulfur atom.

17. A silver halide photographic material according to claim 5,
wherein Y is a sulfur atom.

18. A silver halide photographic material according to claim 6,
wherein Y′ is a sulfur atom.

19. A silver halide photographic material according to claim 1,
wherein R¹— is represented by formula (V), wherein 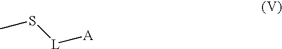
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

20. A silver halide photographic material according to claim 2,
wherein R¹— is represented by formula (V), wherein 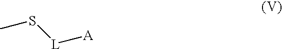
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

21. A silver halide photographic material according to claim 3,
wherein R¹— is represented by formula (V), wherein 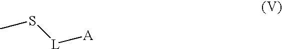
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

22. A silver halide photographic material according to claim 4,
wherein R¹— is represented by formula (V), wherein 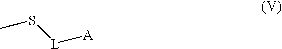
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

23. A silver halide photographic material according to claim 5,
wherein R¹— is represented by formula (V), wherein 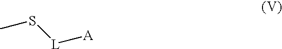
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

24. A silver halide photographic material according to claim 6,
wherein R¹— is represented by formula (V), wherein 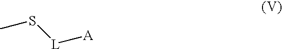
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

25. A silver halide photographic material according to claim 13,
wherein R¹— is represented by formula (V), wherein 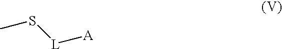
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

26. A silver halide photographic material according to claim 14,
wherein R¹— is represented by formula (V), wherein 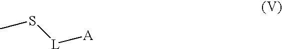
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

27. A silver halide photographic material according to claim 15,
wherein R¹— is represented by formula (V), wherein 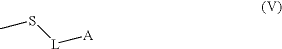
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

28. A silver halide photographic material according to claim 16,
wherein R¹— is represented by formula (V), wherein 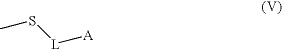
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

29. A silver halide photographic material according to claim 17,
wherein R¹— is represented by formula (V), wherein 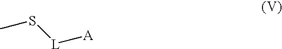
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

30. A silver halide photographic material according to claim 18,
wherein R¹— is represented by formula (V), wherein 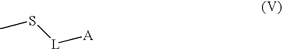
wherein:
A is a solubilizing group selected from the group consisting of a carboxylic acid, a sulfonic acid, a phosphonate, a phosphate, a sulfate and an acylsulfonamide or a corresponding salt thereof, and
L represents an aliphatic divalent linking group.

31. A silver halide material according to claim 2, wherein said compound (II) is represented by following formulae:

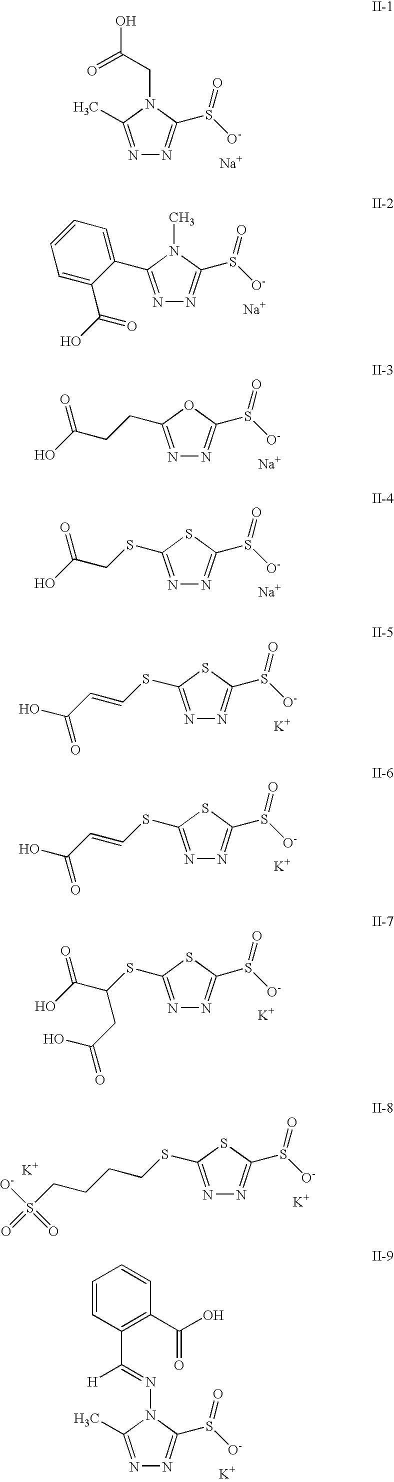

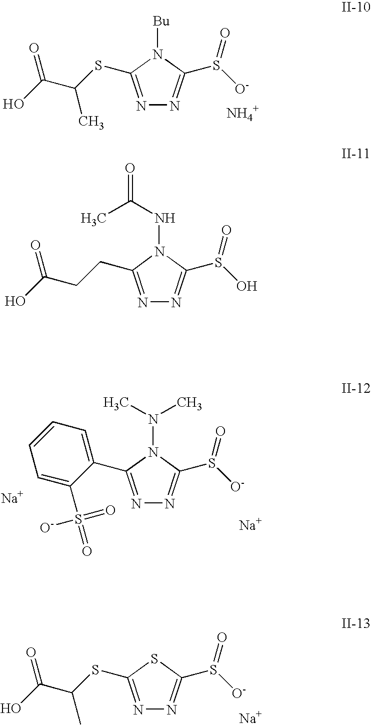

32. A silver halide material according to claim 3, wherein said compound (III) is represented by following formulae:

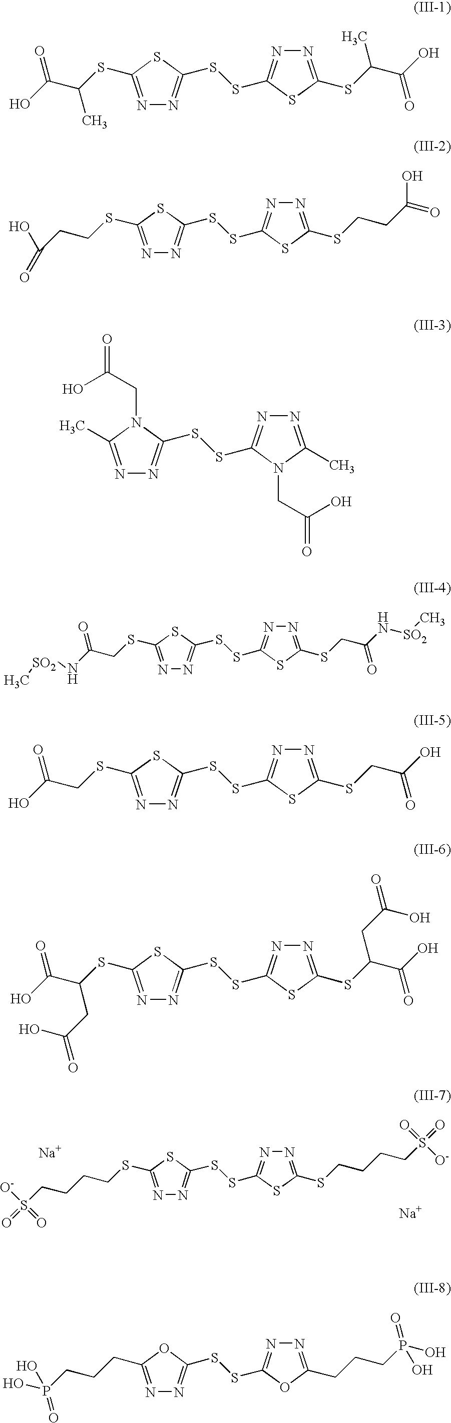

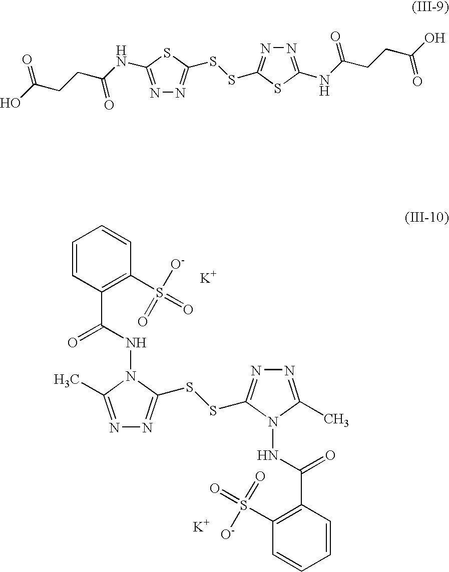

33. A silver halide photographic material according to claim 1, wherein at least one of the compounds according to formula (I) is present in the light-sensitive silver halide emulsion layer or in a layer adjacent thereto, in an amount from 10⁻⁶ to 10⁻¹ mol per mol of silver halide.

34. A silver halide photographic material according to claim 2, wherein at least one of the compounds according to formula (II) is present in the light-sensitive silver halide emulsion layer or in a layer adjacent thereto, in an amount from 10⁻⁶ to 10⁻¹ mol per mol of silver halide.

35. A silver halide photographic material according to claim 3, wherein at least one of the compounds according to formula (III) is present in the light-sensitive silver halide emulsion layer or in a layer adjacent thereto, in an amount from 10⁻⁶ to 10⁻¹ mol per mol of silver halide.

36. A silver halide photographic material according to claim 1, wherein at least one of the compounds according to the formula (I) is present in the light-sensitive silver halide emulsion layer or in a layer adjacent thereto, in an amount from 0.25×10⁻³ to 10⁻¹ mol per mol of silver halide.

37. A silver halide photographic material according to claim 2, wherein at least one of the compounds according to the formula (II) is present in the light-sensitive silver halide emulsion layer or in a layer adjacent thereto, in an amount from 0.25×10⁻³ to 10⁻¹ mol per mol of silver halide.

38. A silver halide photographic material according to claim 3, wherein at least one of the compounds according to the formula (III) is present in the light-sensitive silver halide emulsion layer or in a layer adjacent thereto, in an amount from 0.25×10⁻³ to 10⁻¹ mol per mol of silver halide.

39. A silver halide photographic material according to claim 1, wherein the coating amount of the tabular silver halide grains, expressed as an equivalent amount of silver nitrate, is in a range of from 0.1 to 6 g/m².

40. A silver halide photographic material according to claim 2, wherein the coating amount of the tabular silver halide grains, expressed as an equivalent amount of silver nitrate, is in a range of from 0.1 to 6 g/m².

41. A silver halide photographic material according to claim 3, wherein the coating amount of the tabular silver halide grains, expressed as an equivalent amount of silver nitrate, is in a range of from 0.1 to 6 g/m².

42. A silver halide photographic material according to claim 1, wherein said emulsion layer comprises tabular grains having a thickness in the range from 0.15 μm up to 0.25 μm, wherein said grains having an aspect ratio in the range from 8:1 up to 15:1 represent a projective surface area of at least 70% of the total projected surface.

43. A silver halide photographic material according to claim 2, wherein said emulsion layer comprises tabular grains having a thickness in the range from 0.15 μm up to 0.25 μm, wherein said grains having an aspect ratio in the range from 8:1 up to 15:1 represent a projective surface area of at least 70% of the total projected surface.

44. A silver halide photographic material according to claim 3, wherein said emulsion layer comprises tabular grains having a thickness in the range from 0.15 μm up to 0.25 μm, wherein said grains having an aspect ratio in the range from 8:1 up to 15:1 represent a projective surface area of at least 70% of the total projected surface.

45. A silver halide photographic material according to claim 1, wherein said film material is a radiographic single-side coated material.

46. A silver halide photographic material according to claim 1, wherein said film material is a radiographic double-side coated material.

47. A silver halide photographic material according to claim 45, wherein said film material is a radiographic single-side coated material.

48. A silver halide photographic material according to claim 46, wherein said film material is a radiographic single-side coated material.
